(19) United States
(12) Patent Application Publication
(10) Pub. No.: US 2023/0110123 A1
(43) Pub. Date: Apr. 13, 2023

(54) Station, Method for Selecting Value of OBO Counter of Station and Electronic Device

(71) Applicant: TP-Link Corporation Limited, Hong Kong (CN)

(72) Inventors: Wanyi LI, Shenzhen (CN); Changqiang WU, Shenzhen (CN)

(21) Appl. No.: 17/962,565

(22) Filed: Oct. 10, 2022

(30) Foreign Application Priority Data
Oct. 11, 2021 (CN) 202111179892.2

(51) Int. Cl. H04W 74/08

(52) U.S. Cl. CPC H04W 74/085

(57) ABSTRACT

Disclosed in the present disclosure is a station, method for selecting value of OBO counter of station and electronic device. The method includes: acquiring a Beacon message sent by an access point (AP); computing the count of unallocated stations allocated no RU among the associated stations according to the count of the associated stations; acquiring a count of contentious RUs allocated to the associated stations by the AP in the previous trigger frame; computing a count of contention-failed RUs in the contentious RUs allocated to the associated stations by the AP in the previous trigger frame according to the frequency underutilization rate; and determining a value of the OBO counter according to the count of the unallocated stations, the count of the contentious RUs and the count of the contention-failed RUs.

### CROSS-REFERENCE TO RELATED APPLICATION

The present disclosure claims the priority of Chinese Patent Application No. 202111179892.2, filed on Oct. 11, 2021, and entitled “Station, Value Selection Method for OBO Counter of Station, Electronic Device and Storage Medium”, which is appended herein by reference in its entirety.

### TECHNICAL FIELD

The present disclosure relates to the technical field of communication, and particularly relates to a station, a method for selecting a value of an OBO counter of the station and an electronic device.

### BACKGROUND

As the 802.11 ax protocol introduces an orthogonal frequency division multiple access (OFDMA) technique, i.e., a multiple access technique, an access point (AP) and a station (STA) can support random resource unit (RU) access. In view of this, the AP needs to maintain an OFDMA contention window (OCW) required for a random access RU, and the STA needs to maintain an OFDMA back-off (OBO) counter required for a random access RU.

In a case of the STA contends for the RU, the STA selects a random number as a value of the OBO counter at the beginning, and then the AP sends a contention trigger frame used for triggering uplink RU access once. The uplink RU includes a deterministic RU and a random access RU (the random access RU is an available RA-RU in a current round). If the STA is not allocated the deterministic RU, a count of the RA-RU in the current round is subtracted from the value of the OBO counter of the STA until the value reaches 0. In the case that the value is 0 in this round after the random number is subtracted by the STA, it indicates contention success, and the STA will randomly select an RU and occupy it. Thus, the value of the OBO counter determines the time of RU random access by the STA, that is, the value of the OBO counter within a proper range can increase the opportunity of contention success of the STA. However, being unspecified in the 802.11 ax protocol, a specific value selection mode of the OBO counter is replaced with a random number generation mode, so the STA uses the same random number generation mode in different environments, tending to cause access collision and further resulting in a low STA contention success rate.

### SUMMARY

The embodiments of the present disclosure provide a method for selecting a value of an OBO counter of a station. The method includes:
a Beacon message sent is acquired, after an AP sends a trigger frame and completes data interaction every time, by the AP; where the Beacon message includes a frequency underutilization rate of an RU in a previous trigger frame and a count of associated stations that establish an association relation with the current AP;
a count of unallocated stations allocated no RU among the associated stations is computed, according to the count of the associated stations;
a count of contentious RUs allocated to the associated stations by the AP in the previous trigger frame is acquired, and the contentious RUs mean that RUs are available through contention;
a count of contention-failed RUs in the contentious RUs allocated to the associated stations by the AP in the previous trigger frame is computed, according to the frequency underutilization rate, and the contention-failed RUs mean that remaining RUs due to failed competition; and
a value of the OBO counter is determined according to the count of the unallocated stations, the count of the contentious RUs and the count of the contention-failed RUs.

Optionally, the count of unallocated stations allocated no RU among the associated stations is computed, according to the count of the associated stations includes:
a count of allocated stations allocated RUs among the associated stations from the previous trigger frame is acquired; and
the count of the unallocated stations allocated no RU is computed, according to the count of the associated stations and the count of the allocated stations,

Optionally, the count of contentious RUs allocated to the associated stations by the AP in the previous trigger frame is acquired, includes:
a first bandwidth value that is carried in the Beacon message and occupied by the contentious RUs in the previous trigger frame is acquired;
a second bandwidth value of the contention-failed RUs in the contentious RUs is computed;
a count of RUs to be determined is computed according to the frequency underutilization rate, the first bandwidth value and the second bandwidth value;
in a case of the count of the RUs to be determined is greater than the count of the contention-failed RUs, for which the associated stations fail to contend, allocated by the AP in the previous trigger frame, the count of the contention-failed RUs is selected as the count of the contentious RUs allocated to the associated stations by the AP in the previous trigger frame; and
in a case of the count of the RUs to be determined is less than or equal to the count of the contention-failed RUs, the count of the RUs to be determined is selected as the count of the contentious RUs allocated to the associated stations by the AP in the previous trigger frame.

Optionally, the value of the OBO counter is determined according to the count of the unallocated stations, the count of the contentious RUs and the count of the contention-failed RUs includes:
several counts of the unallocated stations, several counts of the contentious RUs and several counts of the contention-failed RUs are acquired, and average values separately are computed;
a contention success probability of the current station for the contentious RUs is computed, according to the average value of the counts of the unallocated stations, the average value of the counts of the contentious RUs and the average value of the counts of the contention failed RUs;
a ratio of the average value of the counts of the contentious RUs to the contention success probability is selected as a real-time contention window value; and
in a case of the real-time contention window value is greater than a preset contention window threshold, the contention window threshold is selected as the value of the OBO counter.

Optionally, the value of the OBO counter is determined according to the count of the unallocated stations, the count of the contentious RUs and the count of the contention-failed RUs includes:
in a case of the real-time contention window value is less than or equal to the preset contention window threshold, an end value of a serial number of the current station and a current time point are acquired ;
a product of the end value of the serial number and the current time point is computed; and
an end value of the product is acquired, and the value of the OBO counter is determined according to the end value of the product in a value range from a preset reference value to the real-time contention window value.

Optionally, the value of the OBO counter is determined according to the end value of the product in the value range from the preset reference value to the real-time contention window value includes:
in a case of the end value of the product is not 0, the end value of the product with several preset data intervals are compared, to a target data interval corresponding to the end value of the product is determined;
a corresponding target value selection range is determined according to the target data interval in the value range from the reference value to the real-time contention window value; and
a value from the target value selection range randomly is selected as the value of the OBO counter.

Optionally, the value of the OBO counter is determined according to the end value of the production the value range from the preset reference value to the real-time contention window value includes:

in a case of the end value of the product is 0, data from the value range from the reference value to the real-time contention window value randomly is selected as the value of the OBO counter.

In order to achieve the above objective, the embodiments of the present disclosure further provide a station. The station includes:
a message acquiring component configured to acquire a Beacon message sent, after an AP sends a trigger frame and completes data interaction every time, by the AP; where the Beacon message includes a frequency underutilization rate of an RU in a previous trigger frame and a count of associated stations that establish an association relation with the current AP;
an unallocated station count determination component configured to compute a count of unallocated stations allocated no RU among the associated stations, according to the count of the associated stations;
a contentious RU count determination component configured to acquire a count of contentious RUs allocated to the associated stations by the AP in the previous trigger frame, and the contentious RUs mean that RUs are available through contention ;
a contention-failed RU count determination component configured to compute a count of contention-failed RUs in the contentious RUs allocated to the associated stations by the AP in the previous trigger frame, according to the frequency underutilization rate, and the contention-failed RUs mean that remaining RUs due to failed competition; and
an OBO counter value selection component configured to determine a value of an OBO counter according to the count of the unallocated stations, the count of the contentious RUs and the count of the contention-failed RUs.

In order to achieve the above objective, the embodiments of the present disclosure further provide an electronic device. The electronic device includes a processor, a memory and a computer program stored in the memory and configured to be executed by the processor, and the processor executes a method for selecting a value of an orthogonal frequency division multiple access back-off (OBO) counter of a station, and the method includes:
a Beacon message sent is acquired, after an AP sends a trigger frame and completes data interaction every time, by the AP; where the Beacon message includes a frequency underutilization rate of an RU in a previous trigger frame and a count of associated stations that establish an association relation with the current AP;
a count of unallocated stations allocated no RU among the associated stations is computed, according to the count of the associated stations;
a count of contentious RUs allocated to the associated stations by the AP in the previous trigger frame is acquired, and the contentious RUs mean that RUs are available through contention;
a count of contention-failed RUs in the contentious RUs allocated to the associated stations by the AP in the previous trigger frame is computed, according to the frequency underutilization rate, and the contention-failed RUs mean that remaining RUs due to failed competition; and
a value of the OBO counter is determined according to the count of the unallocated stations, the count of the contentious RUs and the count of the contention-failed RUs.

### BRIEF DESCRIPTION OF THE DRAWINGS

FIG. 1 is a flowchart of a method for selecting a value of an OBO counter of a station provided in some embodiments of the present disclosure;

FIG. 2 is a schematic diagram of a format of a basic service set provided in some embodiments of the present disclosure;

FIG. 3 is a structural schematic diagram of a station provided in some embodiments of the present disclosure; and

FIG. 4 is a structural schematic diagram of an electronic device provided in some embodiments of the present disclosure.

### DETAILED DESCRIPTION OF THE EMBODIMENTS

The technical solutions of embodiments of the present disclosure will be described below clearly and comprehensively in conjunction with accompanying drawings of the embodiments of the present disclosure. Apparently, the embodiments described are merely some embodiments rather than all embodiments of the present disclosure. Based on the embodiments of the present disclosure, other various embodiments acquired by those of ordinary skill in the art without making creative efforts fall within the scope of protection of the present disclosure.

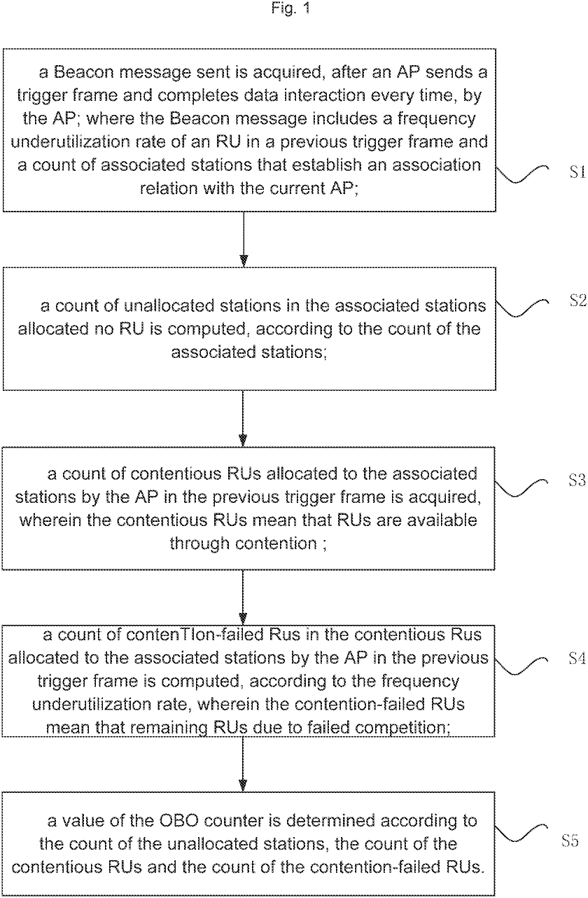

With reference to FIG. 1, FIG. 1 is a flowchart of a method for selecting a value of an OBO counter of a station provided in some embodiments of the present disclosure. The method for selecting the value of the OBO counter of the station includes:
step S1, a Beacon message sent is acquired, after an AP sends a trigger frame and completes data interaction every time, by the AP; where the Beacon message includes a frequency underutilization rate of an RU in a previous trigger frame and a count of associated stations that establish an association relation with the current AP;
step S2, a count of unallocated stations allocated no RU among the associated stations is computed, according to the count of the associated stations;
step S3, a count of contentious RUs allocated to the associated stations by the AP in the previous trigger frame is acquired, and the contentious RUs mean that RUs are available through contention ;
step S4, a count of contention-failed RUs in the contentious RUs allocated to the associated stations by the AP in the previous trigger frame is computed, according to the frequency underutilization rate, and the contention-failed RUs mean that remaining RUs due to failed competition; and
step S5, a value of the OBO counter is determined according to the count of the unallocated stations, the count of the contentious RUs and the count of the contention-failed RUs.

It is worth noting that the method for selecting the value of the OBO counter of the station is executed and implemented by the station, and the station is a client STA, for example, a mobile phone, a computer and other clients.

Specifically, in step S1, the AP starts sending a Beacon message to the station at each Beacon interval period, with the default period being 100 ms and being adjustable. The Beacon message is used for broadcasting common parameter information (including load information) of a basic service set (BSS) to the station, such that the station acquires information of the AP by means of the Beacon message. It is worth noting that the Beacon message is different from the trigger frame sent by the AP, and the trigger frame is used for sending an uplink message to the station which has received the trigger frame.

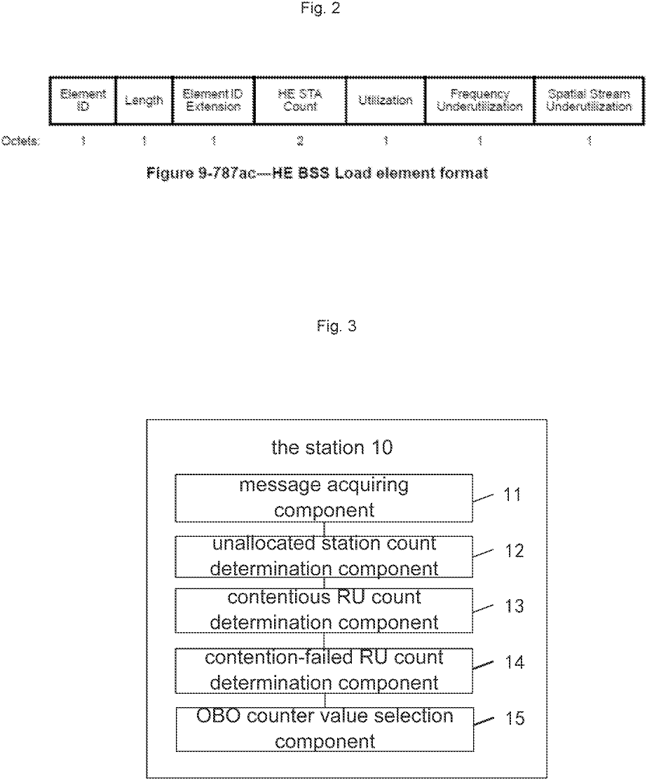

Illustratively, reference may be made to FIG. 2 for a message format of the BSS. In the FIG. 2, Element ID is an ID of the message; Length is a length of the message; Element ID Extension is an ID extension of the message; HE SAT Count is the count of the associated stations; Utilization is a utilization rate and represents the proportion of time of busyness of a current channel due to transmissions between the AP and the station, which is detected by the AP; Frequency Underutilization is a frequency underutilization rate and represents the proportion of time in a case of the AP underutilizes a frequency domain resource due to channel busyness in a certain period; and Spatial Stream Underutilization is a spatial resource underutilization rate and represents the proportion of time in a case of the AP underutilizes a spatial domain resource within given channel busyness time. The Beacon message includes the frequency underutilization rate (that is, Frequency Underutilization) of the RU in the previous trigger frame and the count of the associated stations (that is, HE SAT Count) that establish an association relation with the current AP.

The frequency underutilization rate satisfies the following equation:

$${\text{F}}_{\text{U}} = \left⌊\frac{{\text{T}}_{\text{busy}} - {\sum }_{\text{i=1}}^{\text{N}} \left\{\left({\sum }_{\text{j=1}}^{{\text{N}}_{\text{RU}}} {\text{B}}_{\text{j,i}} ∗ {\text{RU}}_{\text{j}}\right) ∗ {\text{T}}_{\text{i}}\right\}}{{\text{T}}_{\text{busy}}} ∗ 255\right⌋ ;$$

in the equation, F_{U} is the frequency underutilization rate; T_{busy} represents a count of microseconds in which a clear channel assessment (CCA) indicates that the channel is busy due to transmissions between the AP and the station during channel measurement; Tᵢ is a time interval in microseconds, i represents the i-th time interval during which a primary 20 MHz channel is busy due to transmissions between the AP and the station; N is the total count of a channel busy event occurring in a total channel measurement time; N_{RU} is the count of allocated RUs in a basic service set (BSS) bandwidth in a time interval Tᵢ; RUⱼ is a normalization factor depending on the RU size, and equal to a ratio of the j-th RU size to the maximum RU size in the basic service set BSS bandwidth; and B_{j,i} is 1 under the condition that the j-th RU is occupied or interfered in time Tᵢ, and is 0 otherwise.

Specifically, step S2 of the count of unallocated stations allocated no RU among the associated stations is computed, according to the count of the associated stations includes step S21- step S22:
step S21, a count of allocated stations allocated RUs among the associated stations from the previous trigger frame is acquired; and
step S22, the count of the unallocated stations allocated no RU is computed, according to the count of the associated stations and the count of the allocated stations.

Illustratively, the station also needs to analyze the allocation of the RU by the AP in the previous trigger frame. The count of the allocated stations in the associated stations allocated the RUs from the previous trigger frame satisfies: Count of associated station-Count of allocated station = Count of unallocated station, and the unallocated stations may all be considered potential RU contenders.

Specifically, step S3: the count of contentious RUs allocated to the associated stations by the AP in the previous trigger frame is acquired, includes step S31- stepS35:
step S31, a first bandwidth value that is carried in the Beacon message and occupied by the contentious RUs in the previous trigger frame is acquired;
step S32,a second bandwidth value of the contention-failed RUs in the contentious RUs is computed;
step S33, a count of RUs to be determined is computed according to the frequency underutilization rate, the first bandwidth value and the second bandwidth value;
step S34, in a case of the count of the RUs to be determined is greater than the count of the contention-failed RUs, for which the associated stations fail to contend, allocated by the AP in the previous trigger frame, the count of the contention-failed RUs is selected as the count of the contentious RUs allocated to the associated stations by the AP in the previous trigger frame; and
step S35, in a case of the count of the RUs to be determined is less than or equal to the count of the contention-failed RUs, the count of the RU to be determined is selected as the count of the contentious RUs allocated to the associated stations by the AP in the previous trigger frame.

Illustratively, the last condition that the RU is underutilized (in general, it is considered that all the underutilized RUs are RA-RUs) is calculated by means of the current frequency underutilization rate, and according to RU allocation, how many RUs are underutilized on average may be computed and represented by Q. Since the frequency underutilization rate (Frequency Underutilization) is a statistical value, Q represents only a result of statistical significance, and has representative significance after a certain statistical data is accumulated.

Specifically, the frequency underutilization rate F_{U} is acquired; a first bandwidth value that is carried in the Beacon message and occupied by the contentious RUs in a previous trigger frame is acquired and is marked as B; and the 802.11ax protocol specifies that the sizes of the second bandwidth values of all the contention-failed RUs in the contentious RUs are consistent and given by a field of RU Allocation subfield, and the value (RA-RU size value) is marked as S here.

Specifically, the count Q of the RUs to be determined is computed according to the frequency underutilization rate F_{U}, the first bandwidth value B and the second bandwidth value S, Q satisfies an equation Q=floor(F_{U}*B/S), where the function floor () means rounding down. Assuming that the count of the contention-failed RUs, for which the associated stations fail to contend, allocated by the AP in the previous trigger frame is Q′, and under the condition that Q>Q′, the count Q′ of the contention-failed RUs is selected as the count of contentious RUs allocated to the associated stations by the AP in the previous trigger frame; and under the condition that Q≤Q, the count Q of the RU to be determined is selected as the count of the contentious RUs allocated to the associated stations by the AP in the previous trigger frame.

Specifically, in step S4, the count of the contention failed RU in the contentious RUs allocated to the associated stations by the AP in the previous trigger frame is acquired.

Specifically, step S5: the value of the OBO counter is determined according to the count of the unallocated stations, the count of the contentious RUs and the count of the contention-failed RUs includes step S51-step S54:
step S51, several counts of the unallocated stations, several counts of the contentious RUs and several counts of the contention-failed RUs are acquired, and average values separately are computed;
step S52, a contention success probability of the current station for the contentious RUs is computed, according to the average value of the counts of the unallocated stations, the average value of the counts of the contentious RUs and the average value of the counts of the contention-failed RUs;
step S53, a ratio of the average value of the counts of the contentious RUs to the contention success probability is selected as a real-time contention window value; and
step S54, in a case of the real-time contention window value is greater than a preset contention window threshold, the contention window threshold is selected as the value of the OBO counter.

Illustratively, average values of the counts of unallocated stations, the counts of contentious RUs and the counts of contention-failed RUs are computed separately, to acquire an average value z of the counts of unallocated stations, an average value ү of the counts of contentious RUs and an average value β of the counts of contention-failed RUs. The contention success probability P′=p(ү, z)*[1-p(β, ү)] of the current station for the contentious RUs according to z, ү and β, where p (a, b) represents a probability of randomly selecting a in b. A ration of the average value ү of the counts of the contentious RUs to the contention success probability P′ are selected as a real-time contention window value M, where M=ү/P′ in a case of M is greater than a preset contention window threshold OCW, since the value of the OBO counter must be selected from 0-OCW due to protocol requirements, the contention window threshold OCW is selected as the value of the OBO counter.

Further, the step of a value of the OBO counter is determined according to the count of the unallocated stations, the count of the contentious RUs and the count of the contention-failed RUs further includes step S55- step S57:
step S55, in a case of the real-time contention window value is less than or equal to the preset contention window threshold, an end value of a serial number of the current station and a current time point are acquired ;
step S56, a product of the end value of the serial number and the current time point is computed; and
step S57, an end value of the product is acquired, and the value of the OBO counter is determined according to the end value of the product in a value range from a preset reference value to the real-time contention window value.

Illustratively, in a case of M≤OCW, the value of the OBO counter needs to be further determined, and in this case, the end value of the AID of the station and the current time point are acquired. The AID may be considered as a serial number given to the station by the AP, for example, 73, and then the end number is 3; and the current time point in time is an absolute time (seconds). The product of the end value of the serial number and the current time point is computed, and the value of the OBO counter is determined in the value range from the preset reference value to the real-time contention window value according to the end value of the product. In the embodiments of the present disclosure, the value of the OBO counter is determined by means of the product of the end value of the serial number and the current time point, so as to increase randomness of the OBO, and avoid the conflict of RA-RU access.

Furthermore, step S57: the value of the OBO counter is determined according to the end value of the product in a value range from a preset reference value to the real-time contention window value includes step S571- step S573:
step S571, in a case of the end value of the product is not 0, the end value of the product with several preset data intervals are compared, to a target data interval corresponding to the end value of the product is determined;
step S572, a corresponding target value selection range is determined according to the target data interval in the value range from the reference value to the real-time contention window value; and
step S573, a value from the target value selection range randomly is selected as the value of the OBO counter.

Illustratively, the reference value may be 0. in a case of the end value of the product is not 0, the value range (0-M) from the reference value to the real-time contention window value is divided into several value selection ranges in equal proportion, for example, the value selection ranges are divided into (0, M/3], (M/3, M*⅔], (M*⅔, M]. The count of the preset data intervals is equal to the count of the value selection ranges, each data interval has a corresponding value selection range, and values between the data intervals and the value selection ranges are in direct proportion, for example, the data intervals are divided into (0, 3], (3, 6] and (6, 9]. According to the above division relation, it can be acquired that under the condition that the end value of the product is in the range of (0, 3], the value of the OBO counter is set to be a random number in (0, M/3]; under the condition that the end value of the product is in the range of (3, 6], the value of the OBO counter is set to be a random number in (M/3, M*⅔]; and under the condition that the end value of the product is in the range of (6, 9], the value of the OBO counter is set to be a random number in (M*⅔, M].

Furthermore, S57 the value of the OBO counter is determined according to the end value of the product in a value range from a preset reference value to the real-time contention window value further includes step S574:

step S574, in a case of the end value of the product is 0, data from the value range ([0, M]) from the reference value to the real-time contention window value randomly is selected as the value of the OBO counter.

Compared with the a device known to the inventors , the method for selecting the value of the OBO counter of the station disclosed in the embodiments of the present disclosure includes: firstly, the frequency underutilization rate of an RU in the previous trigger frame in an AP and the count of associated stations that establish the association relation with the current AP are acquired; then the count of unallocated stations allocated no RU among the associated stations is computed according to the count of the associated stations, the count of contentious RUs allocated to the associated stations by the AP in the previous trigger frame is acquired; and finally, the count of contention-failed RUs in the contentious RUs allocated to the associated stations by the AP in the previous trigger frame is computed, according to the frequency underutilization rate, and the value of the OBO counter is determined according to the count of the unallocated stations, the count of the contentious RUs and the count of the contention-failed RUs. In the process of determining the value of the OBO counter, the influence of a factor that the unallocated station is the potential competitor is fully considered, and the value of the OBO counter is determined in combination with the count of the contentious RUs and the count of the contention-failed RUs, that is, the value of the OBO counter is determined according to a resource utilization condition of the current AP, so as to increase the opportunity for successful RU contention by the associated stations, and reduce collision possibility.

With reference to FIG. 3, FIG. 3 is a structural schematic diagram of a station 10 provided in some embodiments of the present disclosure. The station 10 includes:
a message acquiring component 11 configured to acquire a Beacon message sent, after an AP sends a trigger frame and completes data interaction every time, by the AP; and the Beacon message includes a frequency underutilization rate of an RU in a previous trigger frame and a count of associated stations that establish an association relation with the current AP;
an unallocated station count determination component 12 configured to compute, according to the count of the associated stations, the count of unallocated stations allocated no RU among the associated stations;
a contentious RU count determination component 13 configured to acquire, according to the frequency underutilization rate, a count of contentious RUs allocated to the associated stations by the AP in the previous trigger frame;
a contention-failed RU count determination component 14 configured to compute a count of contention-failed RUs in the contentious RUs allocated to the associated stations by the AP in the previous trigger frame; and
an OBO counter value selection component 15 configured to determine a value of an OBO counter according to the count of the unallocated stations, the count of the contentious RUs and the count of the contention-failed RUs.

Optionally, the unallocated station count determination component 12 is specifically configured to:
acquire a count of allocated stations allocated RUs among the associated stations from the previous trigger frame; and
compute the count of the unallocated stations allocated no RU, according to the count of the associated stations and the count of the allocated stations;

Optionally, the contentious RU count determination component 13 is specifically configured to:
acquire a first bandwidth value that is carried in the Beacon message and occupied by the contentious RUs in the previous trigger frame;
compute a second bandwidth value of the contention-failed RUs in the contentious RUs;
compute a count of RUs to be determined according to the frequency underutilization rate, the first bandwidth value and the second bandwidth value;
select, in a case of the count of the RUs to be determined is greater than the count of the contention-failed RUs, for which the associated stations fail to contend, allocated by the AP in the previous trigger frame, the count of the contention-failed RUs as the count of the contentious RUs allocated to the associated stations by the AP in the previous trigger frame; and
select, in a case of the count of the RUs to be determined is less than or equal to the count of the contention-failed RUs, the count of the RU to be determined as the count of the contentious RUs allocated to the associated stations by the AP in the previous trigger frame.

Optionally, the OBO counter value selection component 15 includes:
an average value computation unit configured to acquire several counts of the unallocated stations, several counts of the contentious RUs and several counts of the contention-failed RUs, and compute average values separately;
a contention success probability computation unit configured to compute a contention success probability of the current station for the contentious RUs according to the average value of the counts of the unallocated stations, the average value of the counts of the contentious RUs and the average value of the counts of the contention-failed RUs;
a real-time contention window computation unit configured to select a ratio of the average value of the counts of the contentious RUs to the contention success probability as a real-time contention window value; and
a first value selection unit configured to select the contention window threshold as the value of the OBO counter in a case of the real-time contention window value is greater than a preset contention window threshold.

Optionally, the OBO counter value selection component 15 further includes:
an end value and current time point acquiring unit configured to acquire an end value of a serial number of the current station and a current time point in a case of the real-time contention window value is less than or equal to the preset contention window threshold;
a product computation unit configured to compute a product of the end value of the serial number and the current time point; and
a second value selection unit configured to acquire an end value of the product, and determine the value of the OBO counter according to the end value of the product in a value range from a preset reference value to the real-time contention window value.

Optionally, the second value selection unit is configured to:
compare, in a case of the end value of the product is not 0, the end value of the product with several preset data intervals, to determine a target data interval corresponding to the end value of the product;
determine a corresponding target value selection range in the value range from the reference value to the real-time contention window value according to the target data interval; and
select a value from the target value selection range randomly as the value of the OBO counter.

Optionally, the second value selection unit is further configured to:

select, in a case of the end value of the product is 0, data from the value range from the reference value to the real-time contention window value randomly as the value of the OBO counter.

Compared with the a device known to the inventors , a station 10 disclosed in the embodiments of the present disclosure includes: firstly, a frequency underutilization rate of an RU in a previous trigger frame in an AP and a count of associated stations that establish an association relation with the current AP are acquired; then the count of unallocated stations allocated no RU among the associated stations is computed according to the count of the associated stations, a count of contentious RUs allocated to the associated stations by the AP in the previous trigger frame is acquired; and finally, a count of contention-failed RUs in the contentious RUs allocated to the associated stations by the AP in the previous trigger frame is computed, and a value of the OBO counter is determined according to the count of the unallocated stations, the count of the contentious RUs and the count of the contention-failed RUs. In the process of determining the value of the OBO counter, an influence of a factor that the unallocated station is a potential competitor is fully considered, and the value of the OBO counter is determined in combination with the count of the contentious RUs and the count of the contention-failed RUs, that is, the value of the OBO counter is determined according to a resource utilization condition of the current AP, so as to increase an opportunity for successful RU contention by the associated stations, and reduce collision possibility.

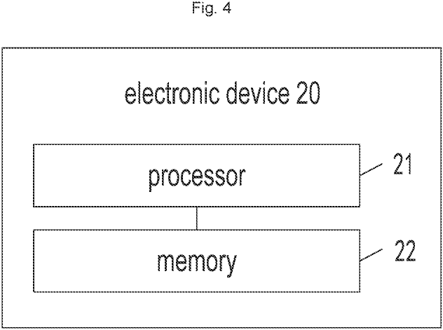

With reference to FIG. 4, FIG. 4 is a structural schematic diagram of an electronic device 20 provided in some embodiments of the present disclosure. The electronic device 20 includes: a processor 21, a memory 22, and a computer program stored in the memory 22 and may run on the processor 21. The processor 21 implements the steps in the above embodiments of the method for selecting the value of the OBO counter of a station in a case of executing the computer program. Alternatively, the processor 21 implements the functions of components/units in the above-mentioned apparatus embodiments in a case of executing the computer program.

Illustratively, the computer program may be divided into one or more components/units, and the one or more components/units are stored in the memory 22 and are executed by the processor 21 to complete the present disclosure. The one or more components/units may be a series of instruction segments of computer program that may implement specific functions, where the instruction segments are used to describe an execution process of the computer program in the electronic device 20.

The electronic device 20 may be a computing device, for example, a desktop computer, a notebook computer, a palm computer, a cloud server, etc. The electronic device 20 may include, but is not limited to, a processor 21 and a memory 22. Those skilled in the art may understand that the schematic diagram is merely an example of the electronic device 20, and does not constitute a limitation on the electronic device 20. More or fewer components than what are shown may be included, or some components or different components may be combined. For example, the electronic device 20 may further include an input and output device, a network access device, a bus, etc.

The processor 21 described above may be a central processing unit (CPU), other general-purpose processors, a digital signal processor (DSP), an application specific integrated circuit (ASIC), a field-programmable gate array (FPGA), other programmable logic devices, a discrete gate, a transistor logic device, a discrete hardware component, etc. The general-purpose processor may be a microprocessor, or the processor may be any conventional processor, etc. The processor 21 is a control center of the electronic device 20, and is used to connect all parts of the entire electronic device 20 by means of various interfaces and lines.

The memory 22 may be configured to store the computer program and/or the components, and the processor 21 is configured to implement various functions of the electronic device 20 by means of running or executing the computer program and/or the components stored in the memory 22 and calling data stored in the memory 22. The memory 22 may mainly include a program storage area and a data storage area. The program storage area may store an operating system, application programs required for at least one function (for example, a sound playback function, and an image display function), etc; and the data storage area may store data (such as audio data, a telephone book, etc.) created according to the use of the mobile phone. Moreover, the memory 22 may include a high-speed random access memory, and may further include a non-volatile memory, for example, a hard disk, an internal memory, and a removable hard disk, a smart media card (SMC), a secure digital (SD), a flash card, at least one disk storage device, a flash storage device or another volatile solid-state storage device.

The component/unit integrated in the electronic device 20 may be stored in a computer-readable storage medium under the condition that it is implemented in the form of a software functional unit and sold or used as an independent product. Based on such an understanding, all or some procedures in the methods in the embodiments implemented in the present disclosure may be accomplished by a computer program instructing related hardware. The computer program may be stored in one computer-readable storage medium, and in a case of executed by a processor 21, the computer program may implement the steps in the method embodiments above. The computer program comprises computer program codes, which may be in the form of source codes, object codes, an executable file or some intermediate forms, etc. The computer-readable medium may include: any entity or apparatus capable of carrying the computer program code, a recording medium, a USB flash drive, a mobile hard disk drive, a magnetic disk, an optical disk, a computer memory, a read-only memory (ROM), a random access memory (RAM), an electrical carrier signal, a telecommunication signal, a software distribution medium, etc. It should be noted that appropriate additions or deletions may be made to the content comprised in the computer-readable medium according to the requirements of the legislation in a jurisdictional area and patent practice. For example, in some jurisdictional areas, according to the legislation and patent practice, the computer-readable medium does not comprise an electrical carrier signal or a telecommunication signal.

It should be noted that the apparatus embodiments described above are merely schematic, the units illustrated as separate components may be physically separate or not, and the components shown as units may be physical units or not, that is, may be located in one place, or may also be distributed over a plurality of network units. Some or all of the components may be selected according to actual needs to achieve the purpose of the solutions of the embodiments. Moreover, in the accompanying drawings of the apparatus embodiments provided in the present disclosure, a connection relation between the components indicates a communication connection between the components and may be implemented as one or more communication buses or signal lines specifically. Those of ordinary skill in the art may understand and implement the present disclosure without making creative efforts.

The foregoing is merely preferred embodiments of the present disclosure, and it should be noted that several improvements and modifications may also be made by those of ordinary skill in the art without departing from the principles of the present disclosure and should also be considered to fall within the scope of protection of the present disclosure.

What is claimed is:

1. A method for selecting a value of an orthogonal frequency division multiple access back-off (OBO) counter of a station, comprising:
acquiring a Beacon message sent, after an access point (AP) sends a trigger frame and completes data interaction every time, by the AP; wherein the Beacon message comprises a frequency underutilization rate of a resource unit (RU) in a previous trigger frame and a count of associated stations that establish an association relation with a current AP;
computing a count of unallocated stations allocated no RU among the associated stations, according to the count of the associated stations;
acquiring a count of contentious RUs allocated to the associated stations by the AP in the previous trigger frame, wherein the contentious RUs mean that RUs are available through contention;
computing a count of contention-failed RUs in the contentious RUs allocated to the associated stations by the AP in the previous trigger frame, according to the frequency underutilization rate, wherein the contention-failed RUs mean that remaining RUs due to failed competition; and
determining a value of the OBO counter according to the count of the unallocated stations, the count of the contentious RUs and the count of the contention-failed RUs.

2. The method for selecting the value of the OBO counter of the station according to claim 1, wherein computing the count of unallocated stations allocated no RU among the associated stations, according to the count of the associated stations comprises:
Acquiring a count of allocated stations allocated RUs among the associated stations from the previous trigger frame; and
computing the count of the unallocated stations allocated no RU, according to the count of the associated stations and the count of the allocated stations.

3. The method for selecting the value of the OBO counter of the station according to claim 1, wherein acquiring the count of contentious RUs allocated to the associated stations by the AP in the previous trigger frame , comprises:
acquiring a first bandwidth value that is carried in the Beacon message and occupied by the contentious RUs in the previous trigger frame;
computing a second bandwidth value of the contention-failed RUs in the contentious RUs;
computing a count of RUs to be determined according to the frequency underutilization rate, the first bandwidth value and the second bandwidth value;
in a case of the count of the RUs to be determined is greater than the count of the contention-failed RUs, for which the associated stations fail to contend, allocated by the AP in the previous trigger frame, selecting the count of the contention-failed RUs as the count of the contentious RUs allocated to the associated stations by the AP in the previous trigger frame; and
in a case of the count of the RUs to be determined is less than or equal to the count of the contention-failed RUs, selecting the count of the RUs to be determined as the count of the contentious RUs allocated to the associated stations by the AP in the previous trigger frame.

4. The method for selecting the value of the OBO counter of the station according to claim 1, wherein determining the value of the OBO counter according to the count of the unallocated stations, the count of the contentious RUs and the count of the contention-failed RUs comprises:
acquiring several counts of the unallocated stations, several counts of the contentious RUs and several counts of the contention-failed RUs, and computing average values separately;
computing a contention success probability of the current station for the contentious RUs according to the average value of the counts of the unallocated stations, the average value of the counts of the contentious RUs and the average value of the counts of the contention-failed RUs;
selecting a ratio of the average value of the counts of the contentious RUs to the contention success probability as a real-time contention window value; and
in a case of the real-time contention window value is greater than a preset contention window threshold, selecting the contention window threshold as the value of the OBO counter.

5. The method for selecting the value of the OBO counter of the station according to claim 4, wherein determining the value of the OBO counter according to the count of the unallocated stations, the count of the contentious RUs and the count of the contention-failed RUs further comprises:
in a case of the real-time contention window value is less than or equal to the preset contention window threshold, acquiring an end value of a serial number of the current station and a current time point;
computing a product of the end value of the serial number and the current time point; and
acquiring an end value of the product, and determining the value of the OBO counter according to the end value of the product in a value range from a preset reference value to the real-time contention window value.

6. The method for selecting the value of the OBO counter of the station according to claim 5, wherein determining the value of the OBO counter according to the end value of the product in a value range from the preset reference value to the real-time contention window value comprises:
in a case of the end value of the product is not 0, comparing the end value of the product with several preset data intervals, to determine a target data interval corresponding to the end value of the product;
determining a corresponding target value selection range according to the target data interval in the value range from the reference value to the real-time contention window value; and
selecting a value from the target value selection range randomly as the value of the OBO counter.

7. The method for selecting the value of the OBO counter of the station according to claim 5, wherein determining the value of the OBO counter according to the end value of the product in a value range from the preset reference value to the real-time contention window value comprises:
in a case of the end value of the product is 0, selecting data from the value range from the reference value to the real-time contention window value randomly as the value of the OBO counter.

8. A station, comprising:
a message acquiring component configured to acquire a Beacon message sent, after an AP sends a trigger frame and completes data interaction every time, by the AP; wherein the Beacon message comprises a frequency underutilization rate of an RU in a previous trigger frame and a count of associated stations that establish an association relation with the current AP;
an unallocated station count determination component configured to compute a count of unallocated stations allocated no RU among the associated stations, according to the count of the associated stations;
a contentious RU count determination component configured to acquire a count of contentious RUs allocated to the associated stations by the AP in the previous trigger frame, wherein the contentious RUs mean that RUs are available through contention ;
a contention-failed RU count determination component configured to compute a count of contention-failed RUs in the contentious RUs allocated to the associated stations by the AP in the previous trigger frame, according to the frequency underutilization rate, wherein the contention-failed RUs mean that remaining RUs due to failed competition; and
an OBO counter value selection component configured to determine a value of an OBO counter according to the count of the unallocated stations, the count of the contentious RUs and the count of the contention-failed RUs.

9. An electronic device, comprising a processor, a memory and a computer program stored in the memory and configured to be executed by the processor, wherein the processor executes a method for selecting a value of an orthogonal frequency division multiple access back-off (OBO) counter of a station, wherein the method comprises:
acquiring a Beacon message sent, after an access point (AP) sends a trigger frame and completes data interaction every time, by the AP; wherein the Beacon message comprises a frequency underutilization rate of a resource unit (RU) in a previous trigger frame and a count of associated stations that establish an association relation with a current AP;
computing a count of unallocated stations allocated no RU among the associated stations, according to the count of the associated stations;
acquiring a count of contentious RUs allocated to the associated stations by the AP in the previous trigger frame, wherein the contentious RUs mean that RUs are available through contention ;
computing a count of contention-failed RUs in the contentious RUs allocated to the associated stations by the AP in the previous trigger frame, according to the frequency underutilization rate, wherein the contention-failed RUs mean that remaining RUs due to failed competition; and
determining a value of the OBO counter according to the count of the unallocated stations, the count of the contentious RUs and the count of the contention-failed RUs.

10. The electronic device according to claim 9, wherein computing the count of unallocated stations allocated no RU among the associated stations, according to the count of the associated stations comprises:
Acquiring a count of allocated stations allocated RUs among the associated stations from the previous trigger frame; and
computing the count of the unallocated stations allocated no RU, according to the count of the associated stations and the count of the allocated stations.

11. The electronic device according to claim 9, wherein acquiring the count of contentious RUs allocated to the associated stations by the AP in the previous trigger frame , comprises:
acquiring a first bandwidth value that is carried in the Beacon message and occupied by the contentious RUs in the previous trigger frame;
computing a second bandwidth value of the contention-failed RUs in the contentious RUs;
computing a count of RUs to be determined according to the frequency underutilization rate, the first bandwidth value and the second bandwidth value;
in a case of the count of the RUs to be determined is greater than the count of the contention-failed RUs, for which the associated stations fail to contend, allocated by the AP in the previous trigger frame, selecting the count of the contention-failed RUs as the count of the contentious RUs allocated to the associated stations by the AP in the previous trigger frame; and
in a case of the count of the RUs to be determined is less than or equal to the count of the contention-failed RUs, selecting the count of the RUs to be determined as the count of the contentious RUs allocated to the associated stations by the AP in the previous trigger frame.

12. The electronic device according to claim 9, wherein determining the value of the OBO counter according to the count of the unallocated stations, the count of the contentious RUs and the count of the contention-failed RUs comprises:
acquiring several counts of the unallocated stations, several counts of the contentious RUs and several counts of the contention-failed RUs, and computing average values separately;
computing a contention success probability of the current station for the contentious RUs according to the average value of the counts of the unallocated stations, the average value of the counts of the contentious RUs and the average value of the counts of the contention-failed RUs;
selecting a ratio of the average value of the counts of the contentious RUs to the contention success probability as a real-time contention window value; and
in a case of the real-time contention window value is greater than a preset contention window threshold, selecting the contention window threshold as the value of the OBO counter.

13. The electronic device according to claim 12, wherein determining the value of the OBO counter according to the count of the unallocated stations, the count of the contentious RUs and the count of the contention-failed RUs further comprises:
in a case of the real-time contention window value is less than or equal to the preset contention window threshold, acquiring an end value of a serial number of the current station and a current time point;
computing a product of the end value of the serial number and the current time point; and
acquiring an end value of the product, and determining the value of the OBO counter according to the end value of the product in a value range from a preset reference value to the real-time contention window value.

14. The electronic device according to claim 13, wherein determining the value of the OBO counter according to the end value of the product in the value range from the preset reference value to the real-time contention window value comprises:
in a case of the end value of the product is not 0, comparing the end value of the product with several preset data intervals, to determine a target data interval corresponding to the end value of the product;
determining a corresponding target value selection range according to the target data interval in the value range from the reference value to the real-time contention window value; and
selecting a value from the target value selection range randomly as the value of the OBO counter.

15. The electronic device according to claim 13, wherein determining the value of the OBO counter according to the end value of the product in the value range from the preset reference value to the real-time contention window value comprises:
in a case of the end value of the product is 0, selecting data from the value range from the reference value to the real-time contention window value randomly as the value of the OBO counter.
